(19) United States
(12) Patent Application Publication
(10) Pub. No.: US 2024/0245247 A1
(43) Pub. Date: Jul. 25, 2024

(54) Hook for Suspending a Purse

(71) Applicant: Brittany Scott, Tampa, FL (US)

(72) Inventor: Brittany Scott, Tampa, FL (US)

(21) Appl. No.: 18/099,935

(22) Filed: Jan. 21, 2023

(51) Int. Cl. A47G 29/093; F16B 45/00

(52) U.S. Cl. CPC A47G 29/093; F16B 45/00

(57) ABSTRACT

A compact planar S-shaped hook that suspends purses and handbags from a support structure, such as a chairback or the top of a door. The hook has a top end, a bottom end, a front side, and a rear side. The top end forms an upper loop having a tip adjacent to the front side with a space therebetween. The bottom end forms a bottom loop having a tip adjacent to the rear side with space therebetween. A portion of an article is retained in an interior of the lower loop and a portion of a support structure is retained in an interior of the upper loop. The bottom loop tip has a hook member extending to the rear side, reversibly closing the space existing between the rear side and the bottom loop tip and locking a portion of the article in the interior of the bottom loop.

### FIELD OF THE DISCLOSURE

This disclosure relates to hook devices that support articles hanging therefrom and, more particularly, to a planar hook device that suspends articles from the back of a chair or the top of a door.

### BACKGROUND OF THE DISCLOSURE

When a person is carrying a purse or handbag in public areas there is often a desire or need not to place the purse or handbag on surfaces generally exposed to the public. If there is no hook to hang a purse or handbag, the person must continue holding the purse or handbag. It would be desirable to provide a portable hook device which could be easily carried by the person for use in such situations. US Patent Application No. 20140116585 discloses a portable purse strap hook having a flexible sheet constructed to form a sleeve wrapped around a strap on a purse. A hook is secured inside the sleeve. The portable purse strap hook extends from the sleeve so that the hook may be used to hang the purse from a stationary support. This portable purse strap hook is relatively complex in structure, bulky, requiring that it be mounted to the strap when needed, and is limited in use to purses with straps. A simple hook that does not require complex mounting to the purse, that can be carried on a key chain, and that will also work with purses without straps is desirable.

### SUMMARY OF THE DISCLOSURE

This disclosure provides a planar hook device that suspends articles from a structure. The hook device has a top end, a bottom end, a front side, and a rear side. The top end extends away from the front side and then extends downward towards the bottom end and then extends back towards the front side, thereby forming an upper loop having a tip adjacent to the front side. A space exists between the front side and the upper loop tip.

The bottom end extends away from the rear side and then extends upwards towards the top end and then extends back towards the rear side, thereby forming a bottom loop having a tip adjacent to the rear side. A space exists between the rear side and the bottom loop tip. The bottom loop tip has a hook member extending to the rear side, reversibly closing the space existing between the rear side and the bottom loop tip. The upper loop and the lower loop are springs. The upper loop tip is biased towards the front side and the bottom loop tip is biased towards the rear side. The space between the front side and the upper loop tip provides an opening into an interior of the upper loop and the space between the rear side and the bottom loop tip provides an opening into an interior of the bottom loop. A ring-shaped connecting member is positioned on the bottom end to connect the hook device to a key ring.

A portion of an article, such as a purse or a handbag, for example, is retained in the lower loop. A portion of a support structure, such as the top of the back of a chair or the top of a door, is retained in the upper loop.

An advantage of the hook device of this disclosure is an S-shaped hook that will suspend a purse or a handbag from the back of a chair or from the top of a door, preventing the need to place the purse or handbag on the floor or other areas exposed to public use.

Another advantage is a hook device that is planar and compact which can be stored in a purse or handbag.

Another advantage is a hook device that locks a portion of a purse or handbag to the hook device.

Another advantage is a hook device that can be used to suspend purses or handbags that do not have handles.

### BRIEF DESCRIPTION OF THE DRAWINGS

FIG. 1 shows a side view of the hook device of this disclosure.

FIG. 2 shows a side view of the hook device attached to a top end of a back of a chair.

FIG. 3 shows a side view of the hook device attached to the top end of the back of a chair, as described for FIG. 2, and further shows a purse attached to the hook device by a purse strap.

### DETAILED DESCRIPTION OF THE DISCLOSURE

While the following description details the preferred embodiments of the hooks of this disclosure, it is to be understood that the hooks of this disclosure are not limited in their application to the details of arrangement of the features or parts described in the disclosure, since the hooks are capable of other embodiments and of being practiced in various ways.

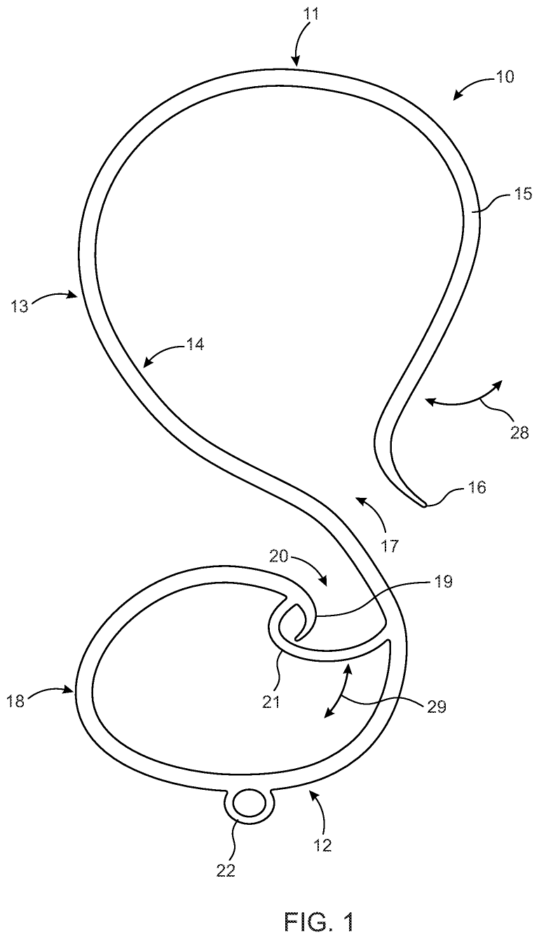

FIG. 1 shows a side view of the hook device 10 of this disclosure. The hook device 10 has a top end 11, a bottom end 12, a rear side 13, and a front side 14 which, preferably, form an S-shape. The top-end 11 extends away from the front side 14 and then downward towards the bottom end 12 and then back towards the front side 14 forming a loop 15 (top loop) which is configured as a spring. The loop 15 ends in a tip 16 which is adjacent to and spaced apart from the front side 14 and provides an opening 17 into the interior of the loop 15.

The bottom end 12 extends away from the rear side 13 and upwards towards the top end 11 forming a loop 18 (bottom loop) which is constructed as a spring. The loop 18 ends in a tip 19 which is adjacent and spaced apart from the rear side 13 and provides an opening 20 into an interior of the loop 18. The tip 19 has a barb or hook member 21 that extends therefrom to the rear side 13. The hook member 21 engages the rear side 13 but is not attached thereto. The loops 15 and 18 are springs.

The tip 16 of loop 15 can be moved inward and outward in the directions of arrows 28. The tip 19 and the hook member 21 can be moved downward and upward in the directions of arrows 29. The tip 16 of loop 15 is biased towards the front side 14 and the tip 19 and hook member 21 of loop 18 are biased towards the rear side 13.

A ring-shaped attachment member 22 is positioned on the bottom end 12 of hook device 10. The ring-shaped member 22 allows the hook device 10 to be attached to a key ring or similar device.

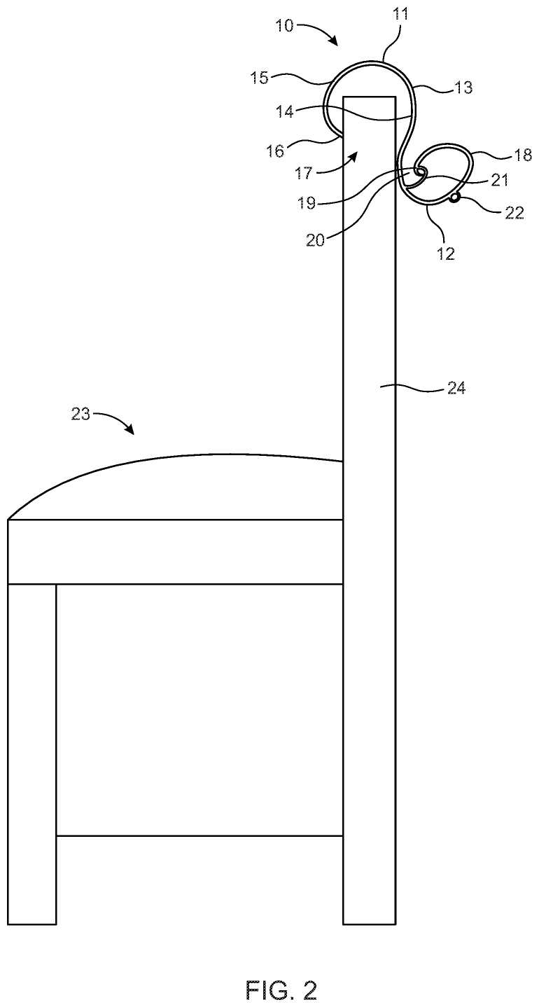

FIG. 2 shows a side view of the hook device 10 attached to a top end of a back 24 of a chair 23. The top end of the chair is inserted through the opening 17 and inserted into the interior of loop 15. The force of the spring action of loop 15 retains the loop 15 portion of the chair hook on the top end of the back 24 of the chair 23.

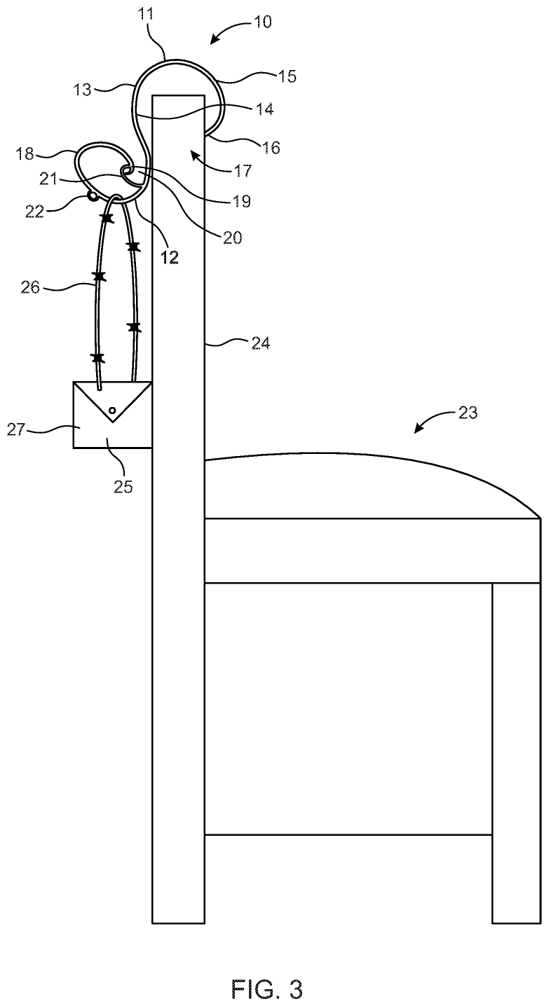

FIG. 3 shows a side view of the hook device 10 attached to a top end of a back 24 of a chair 23 as described for FIG. 2 and further shows a purse 25 attached to the hook device 10 by a purse strap 26. The strap 26 is inserted through opening 19 and pushed against the hook member 21, pushed passed the hook member 21, and pushed into the interior of loop 18 where the strap 26 is retained on hook device 10. The strap 26 is removed from the interior of loop 18 by pushing the hook member 21 away from the rear side 13 and pulling the strap 26 through opening 20 and out of the interior of the loop 18.

A portion of the purse 25, for example a corner 27 of the purse 25, may also be inserted through opening 20, pushed against the hook member 21, and pushed passed the hook member 21 into the interior of loop 18. When pressure is released from the hook member 21 the hook member 21 will press the corner 27 of the purse 25 against the side 13, thereby retaining the purse 25 on the chair hook 10. The corner 27 is removed from the interior of loop 18 by pushing the hook member 21 away from the rear side 13 and pulling the corner 27 through opening 20 and out of the interior of the loop 18.

The hook device can be made of any suitable plastic or metal. Although the ring-shaped attachment member 22 is placed at the bottom of the hook device in can be mounted anywhere on the hook device as desired. The hook device can be made in any desired length and thickness. Although the hook device is shown and described as mounted on the back of a chair by means of the top loop, the hook device can be mounted similarly on any planar structure of suitable thickness, for example, on the top of a door.

The foregoing description illustrates and describes the disclosure. Additionally, the disclosure shows and describes only the preferred embodiments but as mentioned above, it is to be understood that the preferred embodiments are capable of being formed in various other combinations, modifications, and environments and are capable of changes or modifications within the scope of the invention concepts as expressed herein, commensurate with the above teachings and/or the skill or knowledge of the relevant art. The embodiments described herein above are further intended to explain the best modes known by applicant and to enable others skilled in the art to utilize the disclosure in such, or other, embodiments and with the various modifications required by the particular applications or uses thereof. Accordingly, the description is not intended to limit the disclosure to the form disclosed herein. Also, it is intended that the appended claims be construed to include alternative embodiments.

1. A planar hook device that suspends articles from a structure, comprising:
a) a top end, a bottom end, a front side, and a rear side;
b) the top end extending away from the front side and then extending downward towards the bottom end and then extending back towards the front side, thereby forming an upper loop having a tip adjacent to the front side, wherein a space exists between the front side and the upper loop tip; and
c) the bottom end extending away from the rear side and then extending upwards towards the top end and then extending back towards the rear side, thereby forming a bottom loop having a tip adjacent to the rear side, wherein a space exists between the rear side and the bottom loop tip.

2. The planar hook device of claim 1, further comprising the bottom loop tip having a hook member extending to the rear side, reversibly closing the space existing between the rear side and the bottom loop tip.

3. The planar hook device of claim 1, wherein the upper loop and the lower loop are springs, wherein the upper loop tip is biased towards the front side and the bottom loop tip is biased towards the rear side.

4. The planar hook device of claim 1, wherein a space between the front side and the upper loop tip provides an opening into an interior of the upper loop and wherein the space between the rear side and the bottom loop tip provides an opening into an interior of the bottom loop.

5. The planar hook device of claim 1, further comprising a ring-shaped connecting member positioned on the bottom end.

6. The planar hook device of claim 1, further comprising a portion of an article retained in the lower loop.

7. The planar hook device of claim 1, further comprising a portion of a support structure retained in the upper loop.

8. A planar hook device that suspends articles from a structure, comprising:
a) a top end, a bottom end, a front side, and a rear side;
b) the top end extending away from the front side and then extending downward towards the bottom end and then extending back towards the front side, thereby forming an upper loop having a tip adjacent to the front side, wherein a space exists between the front side and the upper loop tip;
c) the bottom end extending away from the rear side and then extending upwards towards the top end and then extending back towards the rear side, thereby forming a bottom loop having a tip adjacent to the rear side, wherein a space exists between the rear side and the bottom loop tip; and
d) the bottom loop tip having a hook member extending to the rear side, reversibly closing the space existing between the rear side and the bottom loop tip, wherein the upper loop and the lower loop are springs and wherein the upper loop tip is biased towards the front side and the bottom loop tip is biased towards the rear side.

9. The planar hook device of claim 8, wherein a space between the front side and the upper loop tip provides an opening into an interior of the upper loop and wherein the space between the rear side and the bottom loop tip provides an opening into an interior of the bottom loop.

10. The planar hook device of claim 8, further comprising a ring-shaped connecting member positioned on the bottom end.

11. The planar hook device of claim 8, further comprising a portion of an article retained in the lower loop.

12. The planar hook device of claim 8, further comprising a portion of a support structure retained in the upper loop.

13. A planar hook device that suspends articles from a structure, comprising:
a) a top end, a bottom end, a front side, and a rear side;
b) the top end extending away from the front side and then extending downward towards the bottom end and then extending back towards the front side, thereby forming an upper loop having a tip adjacent to the front side, wherein a space exists between the front side and the upper loop tip;
c) the bottom end extending away from the rear side and then extending upwards towards the top end and then extending back towards the rear side, thereby forming a bottom loop having a tip adjacent to the rear side, wherein a space exists between the rear side and the bottom loop tip;
d) the bottom loop tip having a hook member extending to the rear side, reversibly closing the space existing between the rear side and the bottom loop tip, wherein the upper loop and the lower loop are springs, wherein the upper loop tip is biased towards the front side and the bottom loop tip is biased towards the rear side, and wherein a space between the front side and the upper loop tip provides an opening into an interior of the upper loop and wherein the space between the rear side and the bottom loop tip provides an opening into an interior of the bottom loop; and
e) a ring-shaped connecting member positioned on the bottom end.

14. The planar hook device of claim 13, further comprising a portion of an article retained in the lower loop.

15. The planar hook device of claim 13, further comprising a portion of a support structure retained in the upper loop.
